(19) United States
(12) Patent Application Publication
(10) Pub. No.: US 2003/0108064 A1
(43) Pub. Date: Jun. 12, 2003

(54) Controlling or monitoring at least two communication systems by at least one application

(75) Inventors: Volkmar Bilke, Salzktton (DE); Bruno Bozionek, Borchen (DE); Dicker Hemkemeyer, Olde (DE); Uwe Langer, Paderbom (DE); Rainer Zimmermann, Paderbom (DE)

Correspondence Address: STAAS & HALSEY LLP, 700 11TH STREET, NW, SUITE 500, WASHINGTON, DC, 20001, US

(73) Assignee: Siemens Akiengesellschaft, Munich (DE)

(21) Appl. No.: 10/310,999

(22) Filed: Dec. 6, 2002

(30) Foreign Application Priority Data
Dec. 6, 2001 (DE) 101 60 027.5

(51) Int. Cl. H04L 12/66

(52) U.S. Cl. 370/466; 379/900

(57) ABSTRACT

At least two communication systems are controlled or monitored by at least one application by transmitting data from an application to a communication system or conversely from a communication system to an application. An interposed shared service receives and processes the data in each case and subsequently forwards the data. The service sends the data to the communication systems in the same data format in each case and receives the data from the communication systems. When at least one of the communication systems uses a different data format, at least one conversion unit is connected between the communication system and the service for adapting the data formats. With this arrangement it is unnecessary to preset the application to the particular data format used by the communication system to transmit control and status information.

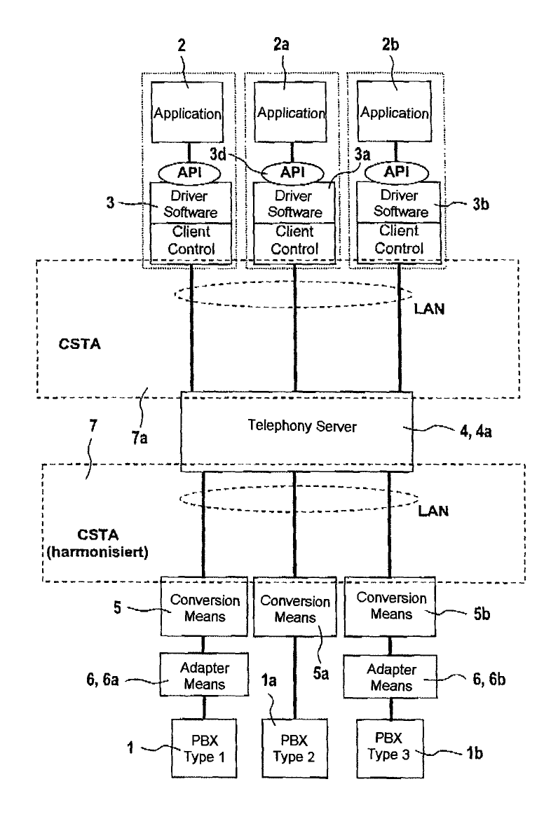

### CROSS REFERENCE TO RELATED APPLICATIONS

This application is based on and hereby claims priority to German Application No. 101 60 027.5 filed on Dec. 6, 2001, the contents of which are hereby incorporated by reference.

### BACKGROUND OF THE INVENTION

1. Field of the Invention

The invention relates to controlling and monitoring at least two communication systems by at least one application.

2. Description of the Related Art

Arrangements in which control and status information is exchanged between communication systems and applications are generally known as CTI solutions, where CTI stands for Computer Telephony Integration. One application area of CTI solutions is for example activating, deactivating and controlling switching features in communication systems. Moreover, CTI solutions permit the display and further processing of status information relating to the subscriber terminals on communication systems, that is to say the call status “free” or “busy” for example. This is also referred to as “monitoring” because different subscriber terminals are monitored and the occurrence of specific events is reported, for example an incoming call.

Both for controlling features with the aid of control information and for displaying and further processing status information, an exchange of data is usually required in both directions, that is to say both from the application to the communication system and in the opposite direction.

This data exchange is referred to in the text below as protocol. The protocol defines the sequence of messages and their structure/contents (data formats). The applications are usually installed on a computer, where they run on top of a programming interface, the so-called API, where API stands for Application Programming Interface. Software frequently also referred to as “driver software” makes the API available and exchanges the transmitted data with a server arranged centrally in the network as a common service, which server is also referred to as telephony or CTI server. The data are exchanged between the application and the telephony server in accordance with a defined protocol, for example the CSTA protocol.

A plurality of applications with which the control and status information is exchanged can be connected to a telephony server. The assignment and distribution of the data to be exchanged between the applications and the communication systems take place in the telephony server. For communication with the telephony server, communication systems have special interfaces that are likewise generally referred to as CTI interfaces. The protocol of the control and status information transmitted via the CTI interfaces depends on the functionality of the respective communication system. The protocols are often manufacturer-specific (proprietary).

In the known arrangements it has proved disadvantageous that the application must be preset to the particular protocol used by the communication system for transmitting control and status information.

### SUMMARY OF THE INVENTION

An object of the invention is to not require the application to be preset to the particular protocol used by the communication system for transmitting control and status information.

The solution is an arrangement for controlling or monitoring at least two communication systems by at least one application, wherein data are transmitted in each case at least one of from an application to a communication system and from a communication system to an application, having an interposed shared service which receives, processes and if appropriate subsequently forwards the data in each case, and wherein the service sends the data to the communication systems in the same data format in each case or receives the data from the communication systems, at least one of the communication systems using a different data format, wherein at least one conversion unit is connected in each case between the communication system and the service for adapting the data formats.

An adaptation of the applications or of the shared service to every data format used by the communication systems for exchanging control and status information can be dispensed with if the data is converted from the data formats of the communication systems into a single data format, and vice versa. In this way it is possible to integrate further communication systems in existing arrangements without having to add a further data format to the central service or to an application.

Applications can be provided with a standard interface in that the same data format of the service is a standardized data format. A particularly effective access to the control and status functions of the communication system is possible if the different data format of the communication system is defined in a proprietary protocol.

A large functionality can be realized with the applications in that the data transmitted include control information for controlling the communication systems and status information of the communication systems.

Conversion units, shared services and communication systems from different manufacturers can be advantageously operated together if the same data format of the service is defined in a harmonized protocol.

If the functionality of the harmonized protocol is adapted to the functionality of the associated communication system in each case by a corresponding version of the protocol, communication systems having different functionalities may be simultaneously used in an arrangement without the lesser functionality of a communication system limiting the functionality attainable with the other communication systems.

Applications can be automatically set to the functionality of the connected communication systems if the harmonized protocol is a standardized CSTA protocol, where CSTA stands for Computer Supported Telephony Application.

Standardized conversion units for connecting communication systems having proprietary data formats can be used if a system-specific adapter for preliminary adaptation is arranged between the conversion unit and the communication system. Security mechanisms for protecting the respective communication systems from erroneous control information may be arranged in the adapter.

Applications can be arranged at a distance from the shared service if the application or the applications and the service are interconnected by a network.

If the network is a LAN, it is possible to realize particularly effective data protection for the connections between the applications and the communication systems using standard methods.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

The single FIGURE is a block diagram of a system for data exchange used for controlling or monitoring communication systems according to the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The FIGURE shows a communication arrangement in which control and status information can be exchanged between applications 2, 2a, 2b and communication systems 1, 1a, 1b. The control of one of the two communication systems 1a by one of the applications 2a is described below by way of example.

To transmit an item of control information from the application 2a to the communication system 1a, the application 2a uses, for example, a TAPI interface (with driver software 3a). On the applications side, the application 2a runs here on top of a programming interface 3d, the so-called API. The application 2a and the driver software 3a are installed together on a PC. The control information is transmitted by the driver software 3a over a network LAN to the telephony server 4a, which provides the shared service 4. (The shared service 4 can of course also be installed on a common PC with driver software 3, 3a, 3b and an application 2, 2a, 2b.)

The data format used to transmit status and control information between each driver software 3, 3a, 3b and the telephony server 4a is a data format conforming to the CSTA protocol. If the data format used by the applications 2, 2a, 2b differs from this data format, the status and control information is converted into the respective different data format in the driver software 3, 3a, 3b. This can be performed for example by a table mapping (Client Control in the FIGURE) of protocol elements.

On the basis of address information it is decided in the telephony server 4a to which of the communication systems 1, 1a, 1b the control information is to be transmitted. It also functions as an intermediate memory (“cache”) and distributor for status information. Owing to its cache function, if appropriate the telephony server 4a can also refrain from forwarding control information. This is the case for example if the function to be influenced by the control information in the communication systems 1, 1a, 1b is already activated or deactivated by previous control information.

The telephony server 4a here transmits the control information first to the conversion unit 5a assigned to the communication system 1a.

Conversion units 5, 5a, 5b provides conversion means and is assigned to each communication system 1, 1a, 1b. The conversion units 5, 5a, 5b are installed on PCs (not illustrated) which are connected to both the telephony server 4a and to the communication systems 1, 1a, 1b by an IP network, where IP stands for Internet Protocol, for example LAN. The conversion units 5, 5a, 5b can of course also be installed on a common PC, and transmission routes other than an IP network LAN, for example serial data lines or ISDN connections, can also be used.

The control information is transmitted between the telephony server 4a and the conversion unit 5a in a standardized data format which is defined in the harmonized CSTA protocol. The telephony server 4a communicates with all conversion units 5, 5a, 5b using this same data format. This is therefore also referred to as a “harmonized protocol layer” or also as a “harmonized protocol layer 7”. (In exactly the same way it is also possible to speak of a harmonized protocol layer 7a for the connections between every driver software 3, 3a, 3b and the telephony server 4a if the data are exchanged over each of these connections in accordance with the same protocol.)

The arrangement caters to the different functionality of different communication systems in that different protocol versions of the CSTA protocol are used in the protocol layer 7 for the connections to the different communication systems; these versions are also referred to as “profiles”. Mechanisms are defined for this purpose in the protocol, with the aid of which the applications 2, 2a, 2b can call up information about the available features of the communication systems 1, 1a, 1b which are defined in the respective profile. A conversion units 5, 5a, 5b can only be omitted if the associated communication system 1, 1a, 1b already uses a data format defined in the CSTA protocol for exchanging the control and status information.

The conversion unit 5a converts the control information to be transmitted into the data format used by the communication system 1a for the interface for exchanging control and status information, which interface is designed as a CTI interface. This data format is defined in its own, usually manufacturer-specific, protocol; this is therefore also referred to as a proprietary data format. The control information is then transmitted by the conversion unit 5a to the communication system 1a in the proprietary data format.

In the FIGURE further adapters 6, 6a, 6b provide adapter means between the conversion units 5, 5b and the communication systems 1, 1b. Such adapters 6 are used for example to form a secure access with a so-called firewall functionality to a—usually not disclosed—manufacturer-specific interface. They are frequently already provided by the manufacturers in communication systems, or are made available by the manufacturer of a communication system as an additional facility. The adapters 6 again changes the data format of the control information which is to be transmitted from the conversion unit 5a to the communication system 1a.

The control and status information which is transmitted from the communication systems 1, 1a, 1b to the applications 2, 2a, 2b travel the described route in the opposite direction. During the transmission of both control information and status information, data are usually transmitted in both directions, that is to say both from the communication systems 1, 1a, 1b to the applications 2, 2a, 2b and also vice versa. The reason for this is firstly that status information is first requested by the applications 2, 2a, 2b from the communication system before it is transmitted by them, and secondly that acknowledgment messages are regularly sent in response to a request when performing feature modifications and other control operations.

The invention has been described in detail with particular reference to preferred embodiments thereof and examples, but it will be understood that variations and modifications can be effected within the spirit and scope of the invention.

What is claimed is:

1. A system for at least one of controlling and monitoring at least two communication systems by at least one application, comprising:
an interposed shared service to at least one of receive first data in a first data format from the at least one application for transmission to one of the communication systems and receive second data in a second data format, different from the first data format, from one of the communication systems for transmission to the at least one application, said interposed shared service processing and as appropriate subsequently forwarding at least one of the first and second data in the second and first data formats, respectively; and
at least one conversion unit, connected between said interposed shared service and at least one of the communication systems, to convert between data formats.

2. The system as claimed in claim 1, wherein said interposed shared service uses a standardized data format.

3. The system as claimed in claim 2, wherein the second data format of the one of the communication systems is defined in a proprietary protocol.

4. The system as claimed in claim 3, wherein at least one of the first and second data include control information for controlling the communication systems and status information of the communication systems.

5. The system as claimed in claim 4, wherein the standardized data format of said interposed shared service is defined in a harmonized protocol.

6. The system as claimed in claim 5, wherein the harmonized protocol has a functionality adapted to a functionality of a corresponding communication system by a corresponding version of the harmonized protocol.

7. The system as claimed in claim 6, wherein the harmonized protocol is a standardized Computer Supported Telephony Application protocol.

8. The system as claimed in claim 7, further comprising a system-specific adapter, connected between said at least one conversion unit and the at least one of the communication systems to provide preliminary adaptation of the second data.

9. The system as claimed in claim 8, further comprising a network interconnecting said interposed shared service and the at least one application.

10. The system as claimed in claim 9, wherein the network is a local area network.

11. A method for at least one of controlling and monitoring at least two communication systems by at least one application, comprising:
transmitting first data from the at least one application towards at least one communication system;
transmitting second data from at least one communication system towards the at least one application;
receiving the first and second data in an interposed shared service between the at least one application and the at least two communication systems;
processing the first and second data in an internal data format of the interposed shared service;
sending the data from the interposed shared service to the at least two communication systems in each case using a data format of received data from the at least two communication systems, respectively, at least one of the communication systems using a different data format than the internal data format of the interposed shared service; and
converting between the internal data format and the different data format in a conversion unit connected between the interposed shared service and the at least one communication system using the different data format.

12. The method as claimed in claim 11, wherein the internal data format of the interposed shared service is a standardized data format.

13. The method as claimed in claim 12, wherein the different data format is defined in a proprietary protocol.

14. The method as claimed in claim 13, wherein at least one of the first and second data include control information for controlling the communication systems and status information of the communication systems.

15. The method as claimed in claim 14, wherein the standardized data format of the interposed shared service is defined in a harmonized protocol.

16. The method as claimed in claim 15, wherein the harmonized protocol has a functionality adapted to a functionality of a corresponding communication system by a corresponding version of the harmonized protocol.

17. The method as claimed in claim 16, wherein the harmonized protocol is a standardized Computer Supported Telephony Application protocol.

18. The method as claimed in claim 17, further comprising preliminarily adapting the second data in a system-specific adapter connected between the conversion unit and the at least one of the communication systems transmitting the second data.
